(19) United States
(12) Patent Application Publication
(10) Pub. No.: US 2007/0141311 A1
(43) Pub. Date: Jun. 21, 2007

(54) Differentially-stretched elastic laminate

(76) Inventors: Mark M. Mleziva, Appleton, WI (US); Michael D. Sperl, Waupaca, WI (US)

Correspondence Address: Melanie I. Rauch;Pauley Petersen & Erickson, Suite 365, 2800 West Higgins Road, Hoffman Estates, IL, 60195, US

(21) Appl. No.: 11/303,029

(22) Filed: Dec. 15, 2005

(51) Int. Cl. B32B 7/02

(52) U.S. Cl. 428/212

(57) ABSTRACT

An elastic material that lowers extension tension over a given range without a significant impact on the retractive tension or stress relaxation. The elastic laminate includes a first set of elastic members attached to one or more substrates while the elastic members are stretched, and a second set of elastic members or an elastic film attached to the one or more substrates while the elastic members or film are stretched to a different extent than the first set of elastic members. Both the substrate(s) and one of the sets of elastic members or film are gathered when the other set of elastic members or film is relaxed. Also included is a method of making the differentially-stretched elastic laminate.

### FIELD OF THE INVENTION

The present invention relates to an elastic laminate that lowers extension tension over a given range without a significant impact on the retractive tension or stress relaxation, and manufacturing methods for making such an elastic laminate.

### BACKGROUND OF THE INVENTION

Elastic materials are typically used to provide stretch and fit capability in waistbands, side panels, and other areas of personal care articles such as diapers, training pants, and swim pants, for example. Personal care articles having elasticized regions are sometimes difficult to don. More particularly, a personal care article having a high extension tension can provide too little useable stretch and can be difficult to apply to a wearer.

Elasticized regions in personal care articles are provided to create a better fit of the garment on the wearer; however, elasticized regions are sometimes the cause of poor fit. For example, a personal care article having a low extension tension is often easy to don, but due to the low tension the article may not conform to the wearer's body but instead may droop or sag. That is, the low extension tension is often accompanied by low retractive tension, which leaves the garment in the stretched position after the initial stretch or does not deliver adequate tension to provide fit or holding power to keep garments adequately in place.

Personal care articles having elasticized regions with a high extension tension typically fit a narrow range of wearers due to the inability to easily or fully stretch the elasticized regions when applying the article to the wearer. Likewise, personal care articles having elasticized regions with a low extension tension also typically fit a narrow range of wearers due to the inability of the elasticized regions to retract effectively after the article has been applied to the wearer.

There is thus a need or desire for elastic materials that deliver a low extension tension without significantly impacting the retractive tension or stress relaxation over time. A material possessing these properties will lower donning tension and help to improve the fit range of any resulting products compared to conventional elastic materials.

### SUMMARY OF THE INVENTION

In response to the discussed difficulties and problems encountered in the prior art, new elastic laminate materials, as well as methods of forming such elastic laminate materials, have been discovered.

In certain embodiments, the elastic laminate includes a first set of elastic members that are attached to a substrate while the elastic members are stretched, and a second set of elastic members that are attached to the substrate while stretched to a lesser extent than the first set of elastic members. When the first set of elastic members is relaxed or allowed to retract, both the substrate and the second set of elastic members are physically or structurally gathered. Alternatively, an elastic film, meltblown, a net structure, or other nonwoven materials may be substituted for one of the sets of elastic members, such that the substrate and one of the elastic components are gathered when the laminate is in a relaxed state.

Suitably, the elastic members of the first set may be interspersed among the elastic members of the second set with none of the elastic members overlapping one another.

The elastic members in the first set of elastic members may have the same basis weight as the elastic members in the second set of elastic members. Alternatively, the two sets of elastic members may have different basis weights. Likewise, the two sets of elastic members may have either the same composition or may differ in composition. Furthermore, the two sets of elastic members may have different heat retractive properties. One or both sets of elastic members may include a styrenic block copolymer.

The first set of elastic members may be attached to the substrate while stretched by about 50% to about 700%. The second set of elastic members may be attached to the substrate while stretched by about 10% to about 500%. In certain embodiments, the first set of elastic members may be attached to the substrate while stretched by about 10% to about 700% more than the second set of elastic members is stretched while being attached to the substrate.

The elastic laminate may include a second substrate, such that the two sets of elastic members, or set of elastic members and film, are attached to both the first and second substrates while stretched.

Methods of making the elastic laminate include attaching the first set of elastic members to the substrate while stretching, or after stretching, the first set of elastic members, and attaching the second set of elastic members or film to the substrate while stretching the second set of elastic members or film to a different extent than the first set of elastic members. The first set of elastic members may be extruded onto a first chill roll while the second set of elastic members is extruded onto a second chill roll. The first set of elastic members may be extruded through an extrusion die having different spacing or spacing that is offset from the spacing of an extrusion die through which the second set of elastic members is extruded. In certain embodiments, one or both sets of elastic members may include pre-formed elastic members. The formed differentially-stretched elastic laminate may be wound onto a roll in a relaxed state, such that the substrate and one set of elastic members or the film are gathered.

The elastic laminate may be incorporated into a personal care article, such as in a waistband, a side panel, and/or a leg band.

With the foregoing in mind, it is a feature and advantage of the invention to provide differentially-stretched elastic laminate materials having reduced extension tension over at least a portion of the extension curve without a similar reduction in retractive tension, with no change in stress relaxation, and improved hysteresis compared to conventional single-stretch stretch-bonded laminates. It is another feature and advantage to provide a method of making such differentially-stretched elastic laminate materials.

### BRIEF DESCRIPTION OF THE DRAWINGS

The invention will be better understood by reference to the following description of embodiments of the invention taken in conjunction with the accompanying drawings, wherein:

FIG. 1 is a top view of one embodiment of a differentially-stretched elastic laminate with the elastic members stretched and the substrate in a relaxed state.

FIG. 2 is a top view of the laminate of FIG. 1 with the elastic members in a relaxed state causing both the substrate and one set of elastic members to be gathered.

FIG. 3 is a top view of the laminate of FIGS. 1 and 2 with one set of elastic members partially stretched causing both the substrate and one set of elastic members to be partially gathered.

FIG. 4 is a top view of the laminate of FIGS. 1-3 with both sets of elastic members stretched, or at least partially stretched, causing at least one set of elastic members to be in a non-gathered state and the substrate to be partially gathered.

FIGS. 5-7 are conceptual line drawings representing the two sets of elastic members in FIGS. 1-3, respectively.

FIG. 8 is an enlarged cross-sectional view taken along line 8-8 of FIG. 1 of one embodiment of a differentially-stretched laminate.

FIGS. 9-11 illustrate cross-sectional views, similar to FIG. 8, of various embodiments of a differentially-stretched laminate.

FIG. 12 is a schematic view illustrating one embodiment of a process by which a differentially-stretched laminate can be prepared.

FIG. 13 is a perspective view of a training pant in which a differentially-stretched elastic laminate material has been incorporated.

FIGS. 14-16 are stress/strain curves of various samples of differentially-stretched elastic laminates in comparison with single-stretch stretch-bonded laminates.

### DEFINITIONS

Within the context of this specification, each term or phrase below will include the following meaning or meanings.

“Attached” refers to the joining, adhering, connecting, bonding, or the like, of two elements. Two elements will be considered to be attached together when they are attached directly to one another or indirectly to one another, such as when each is directly attached to intermediate elements.

“Elastic” or “elastomeric” means that property of a material or composite by virtue of which it tends to stretch when exposed to a stretching force, and to recover most or all of the way to its original size and shape after removal of the stretching force. An elastic material should be able to stretch in at least one direction by at least 50% of its initial (unstretched) length without rupturing, and should immediately recover more than 50% of its stretched length when the stretching force is removed. A hypothetical example that would satisfy this definition of an elastic material would be a one (1) inch sample of a material which is elongatable to at least 1.50 inches and which, upon being elongated to 1.50 inches and released, will recover to a length of less than 1.25 inches. Many elastic materials may be stretched by much more than 50 percent of their relaxed length, and many of these will recover to substantially their original relaxed length upon release of the stretching force.

“Extensible” or “expandable” means elongatable in at least one direction, but not necessarily recoverable.

“Gathered” refers to a layer, laminate, individual strand, or other component that has been contracted into small folds or puckers as a result of an applying force or resultant movement/displacement. Upon application of an extension force, the gathered component may be smoothed out into a non-gathered (relatively flat) relaxed state.

“Heat retractive properties” refer to properties of a material affected by heat in such a way that the retraction of the stretched material can be altered by heat. For example, certain elastic materials can be activated to retract only after the materials have been heated, whereas other elastic materials can have retraction latency imparted through the application of heat.

“Laminate” refers to a composite structure of two or more layers that have been adhered through a bonding step, such as through adhesive bonding, thermal bonding, point bonding, pressure bonding, extrusion coating or ultrasonic bonding.

“Machine direction” or MD refers to the direction along the length of a fabric in the direction in which it is produced. The terms “cross machine direction,” “cross directional,” or CD refer to the direction across the width of fabric, i.e. a direction generally perpendicular to the MD.

“Meltblown fiber” means fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameter, which may be to microfiber diameter. Thereafter, the meltblown fibers are carried by the high velocity gas stream and are deposited on a collecting surface to form a web of randomly dispersed meltblown fibers. Such a process is disclosed for example, in U.S. Pat. No. 3,849,241 to Butin et al.

“Nonwoven” and “nonwoven web” refer to materials and webs of material having a structure of individual fibers or filaments which are interlaid, but not in an identifiable manner as in a knitted fabric. The terms “fiber” and “filament” are used herein interchangeably. Nonwoven fabrics or webs have been formed from many processes such as, for example, meltblowing processes, spunblowing processes, spunbonding processes, air laying processes, and bonded carded web processes. The basis weight of nonwoven fabrics is usually expressed in ounces of material per square yard (osy) or grams per square meter (gsm) and the fiber diameters are usually expressed in microns. (Note that to convert from osy to gsm, multiply osy by 33.91.)

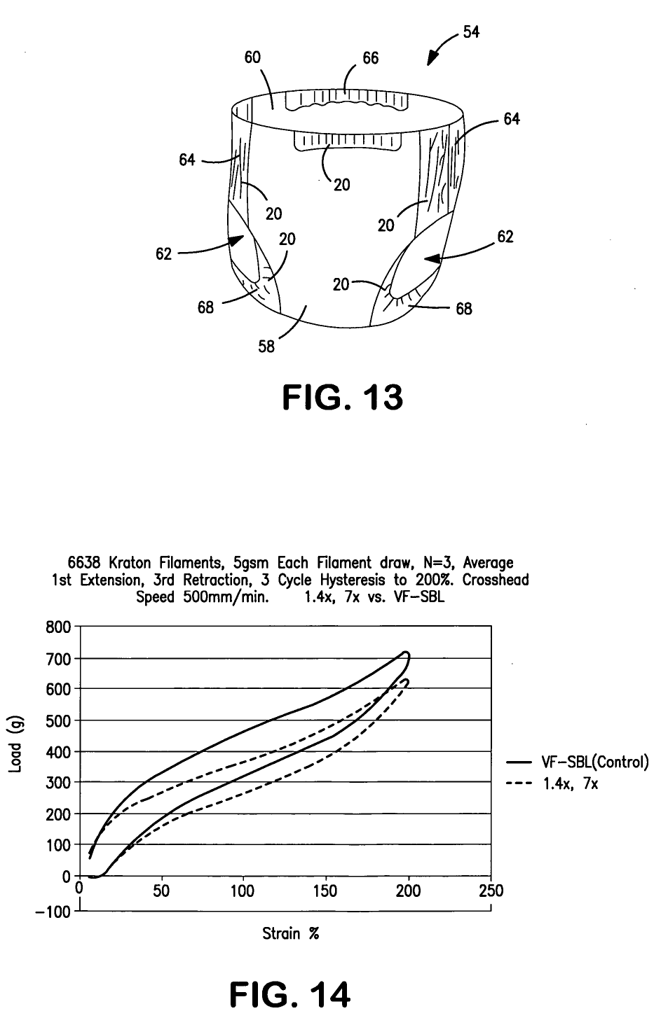

“Personal care article” refers to diapers, training pants, swimwear, absorbent underpants, adult incontinence products, and feminine hygiene products, such as feminine care pads, napkins and pantiliners. While a training pant is illustrated in FIG. 13, it should be recognized that the inventive material may just as easily be incorporated in any of the previously listed personal care articles as an elastic component. For instance, such material may be utilized to make the elastic side panels of training pants. Many personal care articles are disposable garments. The term “disposable garment” includes garments that are typically disposed of after 1-5 uses.

“Polymers,” when used without descriptive modifiers, generally include but are not limited to, homopolymers, copolymers, such as for example, block, graft, random and alternating copolymers, terpolymers, etc. and blends and modifications thereof. Furthermore, unless otherwise specifically limited, the term “polymer” includes all possible spatial configurations of the molecule. These configurations include, but are not limited to isotactic, syndiotactic and random symmetries.

“Spunbond fibers” refers to small diameter fibers which are formed by extruding molten thermoplastic material as filaments from a plurality of fine, usually circular capillaries of a spinneret with the diameter of the extruded filaments then being rapidly reduced as by, for example, in U.S. Pat. No. 4,340,563 to Appel et al.; U.S. Pat. No. 3,692,618 to Dorschner et al.; U.S. Pat. No. 3,802,817 to Matsuki et al.; U.S. Pat. Nos. 3,338,992 and 3,341,394 to Kinney; U.S. Pat. No. 3,502,763 to Hartman; and U.S. Pat. No. 3,542,615 to Dobo et al., each of which is incorporated herein by reference in its entirety in a manner consistent with the present invention. Spunbond fibers are generally not tacky when they are deposited onto a collecting surface. Spunbond fibers are generally continuous and have average diameters (from a sample of at least 10) larger than 7 microns (μm), more particularly, between about 10 and 25 microns (μm), or up to about 30 microns (μm) or more.

“Stretch” or “stretching” refers to the act of applying an extending force to a material that may or may not undergo retraction.

“Stretch-bonded laminate” refers to a composite elastic material made according to a stretch-bonding lamination process, i.e., elastic layer(s) are joined together with additional facing layers when only the elastic layer is in an extended condition (such as by at least about 25 percent of its relaxed length) so that upon relaxation of the layers, the additional layer(s) is/are gathered. Such laminates usually have machine directional (MD) stretch properties and may be subsequently stretched to the extent that the additional (typically non-elastic) material gathered between the bond locations allows the elastic material to elongate. One type of stretch-bonded laminate is disclosed, for example, by U.S. Pat. No. 4,720,415 to Vander Wielen et al., in which multiple layers of the same polymer produced from multiple banks of extruders are used. Other composite elastic materials are disclosed in U.S. Pat. No. 5,385,775 to Wright and copending U.S. Patent Publication No. 2002-0104608, published 8 Aug. 2002, each of which is incorporated by reference herein in its entirety. Such stretch-bonded laminates may include an elastic component that is a web, such as a meltblown web, a film, an array/series of generally parallel continuous filament strands (either extruded or pre-formed), or a combination of such. The elastic layer is bonded in a stretched condition to two inelastic or extendable nonwoven facing materials, such that the resulting laminate is imparted with a textural feel that is pleasing on the hand. In particular, the elastic layer is bonded between the two facing layers, such that the facing layers sandwich the elastic layer. In some instances, the gatherable facing layers may also be necked, such that the stretch-bonded laminate is actually a necked stretch-bonded laminate that may have some extension/elasticity in the cross-machine direction (CD).

These terms may be defined with additional language in the remaining portions of the specification. Unless otherwise indicated, percentages of components in formulations-are by weight.

### DETAILED DESCRIPTION OF THE INVENTION

In accordance with the invention, elastic laminate materials having elastic components with different amounts of applied stretch can aid in optimizing extension tension or lowering tensions without impacting retractive tension or stress relaxation over time. These differentially-stretched elastic laminate materials are useful in a variety of products, including personal care articles. More particularly, the incorporation of such elastic laminate materials into personal care articles results in an article having low donning tension and the ability to fit a wide range of sizes.

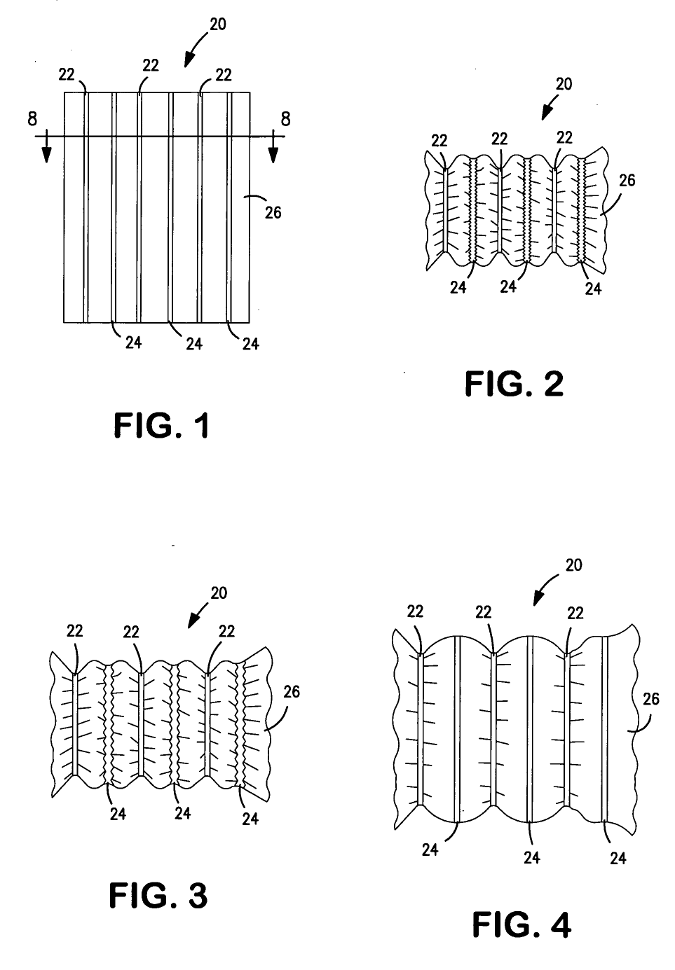

As shown in FIGS. 1-4 a laminate 20 including a first set of elastic members 22 attached to a substrate 26 while the elastic members are stretched, and a second set of elastic members 24 attached to the substrate 26 while stretched to a lesser extent than the first set of elastic members 22, results in both the substrate 26 and the second set of elastic members 24 being gathered when the first set of elastic members 22 is relaxed. More particularly, in FIG. 1, the substrate 26 is in a non-gathered, relaxed state, the first set of elastic members 22 is stretched, for example by about 500% its original length, and the second set of elastic members 24 is stretched to a lesser extent than the first set of elastic members 22, for example by about 250% its original length. The term “relaxed state” refers to a non-stretched state.

In FIG. 2, the laminate 20 is in a relaxed state, wherein both the substrate 26 and the second set of elastic members 24 are gathered as a result of the retraction or shrinkage of the first set of elastic members 22. The laminate 20 may be wound on a roll for storage in the relaxed state configuration shown in FIG. 2.

FIG. 3 illustrates the laminate 20 as the laminate is stretched enough to partially un-gather the second set of elastic members 24, such that the second set of elastic members 24 is in a partially gathered, relaxed state, the substrate 26 is also in a partially gathered, relaxed state, and the first set of elastic members 22 is stretched, such as by about 100% its original length.

FIG. 4 illustrates the laminate 20 as the laminate is stretched enough to un-gather the second set of elastic members 24, such that the second set of elastic members 24 is in a flat, non-gathered, relaxed state, the substrate 20 is still partially gathered, and the first set of elastic members 22 is stretched, such as by about 250% its original length. When the laminate 20 is stretched to the point of un-gathering the substrate 26, the laminate 20 has essentially the same appearance as the laminate in FIG. 1 when the laminate is initially stretch-bonded.

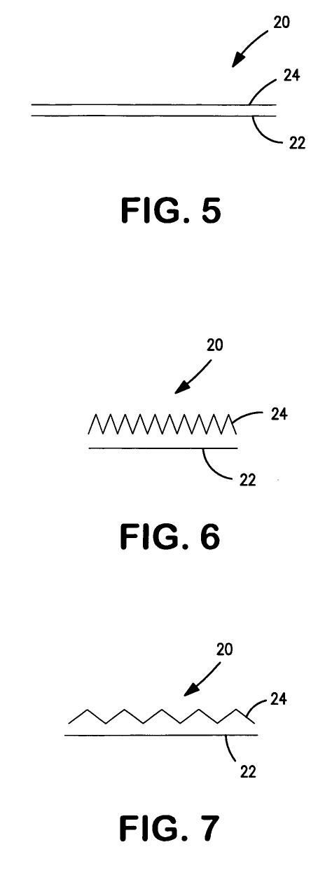

FIGS. 5-7 are conceptual side view illustrations of just the first and second sets of elastic members 22, 24 in FIGS. 1-3, without the substrate 26 shown in order to clearly illustrate the stretched/gathered configurations of the elastic members 22, 24 in the various stretched states of the laminate 20. More particularly, FIG. 5 illustrates both the first and second sets of elastic members 22, 24 in their stretched states, as in FIG. 1, with the first set of elastic members 22 stretched, for example, by about 500% its original length, and the second set of elastic members 24 stretched to a lesser extent than the first set of elastic members 22, for example by about 250% its original length. FIG. 6 conceptually illustrates the laminate 20 wherein the substrate (not shown) is in a relaxed, gathered state, the second set of elastic members 24 is also in a relaxed, gathered state, and the first set of elastic members 22 is in a flat, non-gathered, relaxed state. FIG. 7 conceptually illustrates the laminate 20 as the laminate 20 is stretched enough to partially un-gather the second set of elastic members 24, such that the second set of elastic members 24 is still in a partially gathered, relaxed state, the substrate (not shown) is still gathered, and the first set of elastic members 22 is stretched, such as by about 100% its original length. A conceptual illustration of the first and second sets of elastic members 22, 24 in FIG. 4 would look essentially the same as FIG. 5, with neither of the sets of elastic members 22, 24 being in a relaxed state.

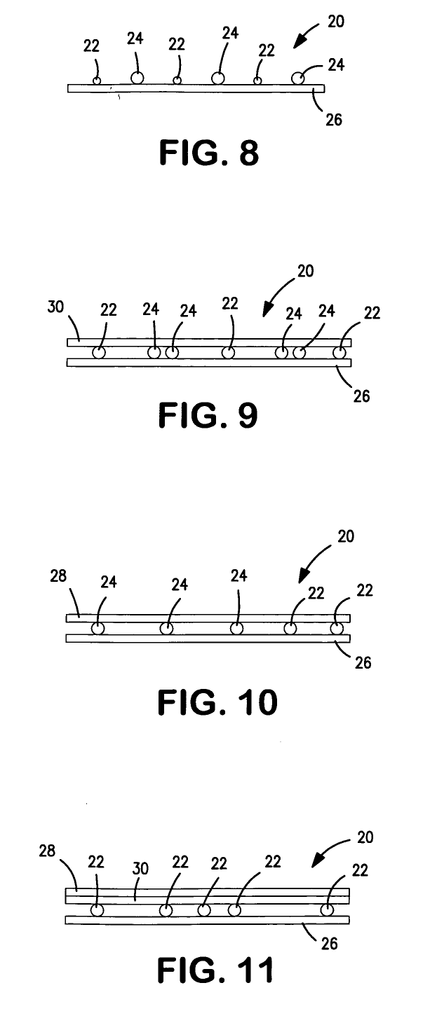

A cross-sectional illustration of the laminate 20 in FIGS. 1-4 is provided in FIG. 8. FIGS. 9-11 illustrate various alternative embodiments of the laminate 20, as described in greater detail below. As shown in the figures, the first set of elastic members 22 can be interspersed among the second set of elastic members 24 without any of the elastic members 22, 24 overlapping one another.

The elastic members in the first set of elastic members 22 can have the same basis weight as the elastic members in the second set of elastic members 24. Alternatively, the first and second sets of elastic members 22, 24 can have different basis weights. For example, the elastic members 22, 24 in either set may have a basis weight between about 2 and about 200 grams per square meter (gsm), or between about 4 and about 50 gsm, or between about 6 and about 20 gsm. In certain embodiments, one or both sets of elastic members 22, 24 may include continuous filaments that are present in an amount between about 0.5 and about 25, or between about 1 and about 20, or between about 2 and about 15 per cross-directional centimeter.

Similarly, the elastic members in the first set of elastic members 22 may have the same material composition and form/structure (for example, meltblown with fiber) as the elastic members in the second set of elastic members 24. Alternatively, the first and second sets of elastic members 22, 24 can have different material/polymer compositions and/or different structures. For example, the elastic members 22, 24 in either set may include filaments, film, foam, scrim, meltblown, or any combination of these or other types of elastic members.

Examples of suitable materials for forming the elastic members 22, 24 include styrenic block copolymers. Specific examples of useful styrenic block copolymers include hydrogenated polyisoprene polymers such as styrene-ethylenepropylene-styrene (SEPS), styrene-ethylenepropylene-styrene-ethylenepropylene (SEPSEP), hydrogenated polybutadiene polymers such as styrene-ethylenebutylene-styrene (SEBS), styrene-ethylenebutylene-styrene-ethylenebutylene (SEBSEB), styrene-butadiene-styrene (SBS), styrene-isoprene-styrene (SIS), and hydrogenated poly-isoprene/butadiene polymer such as styrene-ethylene-ethylenepropylene-styrene (SEEPS). Polymer block configurations such as diblock, triblock, tetrablock, or other multi-block, star and radial are also contemplated in this invention.

Examples of other suitable olefinic copolymers include ethylene-propylene-diene monomer (EPDM), or compounds of any of these elastomeric copolymers, which may be obtained from Kraton Polymers of Houston, Tex., under the trade designation KRATON® elastomeric resin, or from Dexco, a joint venture between Dow Chemical Company and Exxon-Mobil, under the trade designation VECTOR® (SIS polymers). Examples of other suitable materials include polyurethanes, including those available from Invista, under the trade name LYCRA® polyurethane; polyamides, including polyether block amides available from Ato Chemical Company, under the trade name PEBAX® polyether block amide; polyesters, such as those available from E. I. Du Pont de Nemours Co., under the trade name HYTREL(V polyester; polyisoprene; cross-linked polybutadiene; and single-site or metallocene-catalyzed polyolefins, available from Dow Chemical Co. under the trade name AFFINITY®, or a similar material available from ExxonMobil Corporation under the trade name EXACT™.

In certain embodiments, the first set of elastic members 22 may possess different heat retractive properties or a higher or lower modulus than the second set of elastic members 24. More particularly, strands at different elongations or energy states may provide changes in retractive gathering. For example, differentially-stretched strands can deliver tailored or improved heat activation or latency.

Varying the elastic members between the two sets of elastic members 22, 24 in any of the manners discussed herein may allow for further optimization of the differentially-stretched laminate 20 to fit a desired range of wearers. In certain embodiments, the laminate 20 may include more than two sets of differentially stretched elastic members 22, 24. In such embodiments, each set of elastic members is stretched to a different extent when attached to the substrate 26.

As mentioned above, one or both sets of elastic members 22, 24, instead of being a set of strands or filaments, may instead be in the form of an elastic film, meltblown, a net structure, and/or other nonwoven materials. FIG. 9 illustrates a laminate 20 including an elastic film 30. The film 30 may include any of the materials described as being appropriate for the elastic members 22, 24. In embodiments that include one or more films, the film(s) 30 may be stretched in the same manner as the first and/or second sets of elastic members 22, 24 as described in the various embodiments. Furthermore, the film 30 may be included in the laminate in combination with just one of the sets of elastic members 22, 24, or with two or more sets of elastic members, wherein the film 30 and each set of elastic members 22, 24 is attached to the substrate 26 while stretched to a different extent.

The laminate 20 may include a single substrate 26 or, alternatively, two substrates 26, 28, as shown in FIGS. 10 and 11. In embodiments having two substrates, the first and second sets of elastic members 22, 24 are positioned between and attached to both substrates 26, 28 while the elastic members are stretched, such that both substrates 26, 28 and the second set of elastic members 24 are gathered when the first set of elastic members 22 is relaxed.

The substrate 26 or substrates 26, 28 may include a nonwoven web, for example a spunbonded web or a meltblown web, a woven web, or a film. In certain embodiments, the substrate(s) 26, 28 may be non-elastic. Furthermore, the substrate(s) 26, 28 may be extensible. For example, the substrate(s) 26, 28 may be necked, or stretched to impart extensibility in a direction perpendicular to the direction of stretching. Substrates may be formed using conventional processes, including the spunbond and meltblowing processes described in the “DEFINITIONS.” For example, the substrate(s) 26, 28 may include a spunbonded web having a basis weight of about 0.1-4.0 osy, suitably 0.2-2.0 osy, or about 0.4-0.6 osy.

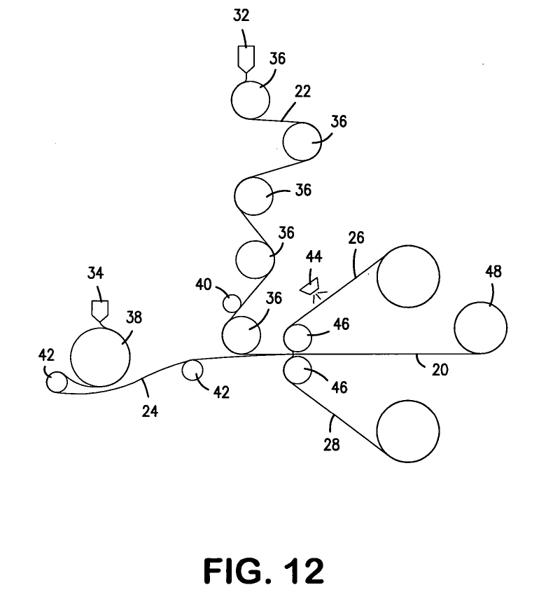

One example of a method of forming the elastic laminate 20 is illustrated schematically in FIG. 12. More particularly, the first set of elastic members 22 is stretched and attached to the facing layers 26, 28, and the second set of elastic members 24 is simultaneously stretched to a lesser extent than the first set of elastic members 22 and is also attached to the facing layers 26, 28. The first set of elastic members 22 can be stretched by about 50% to about 700% during attachment, or by about 100% to about 500%, or by about 150% to about 350%. The second set of elastic members 24 can be stretched by about 10% to about 700% during attachment, or by about 50% to about 600%, or by about 100% to about 500%. In certain embodiments, the first set of elastic members 22 can be stretched by about 10% to about 700%, or by about 50% to about 600%, or by about 100% to about 500% more than the second set of elastic members 24 is stretched while attaching the first and second sets of elastic members to the substrates 26, 28.

As shown in FIG. 12, each of the sets of elastic members 22, 24 can be extruded from a designated extruder 32, 34 onto a corresponding chill roll 36, 38 and stretched at different amounts over a series of idler rolls 40, 42 prior to lamination. Any number of chill rolls 36, 38 and any number of idler rolls 40, 42 may be used to achieve the desired stretch and formation of the elastic members 22, 24. The filament extrusion dies can be of a different spacing or slightly offset from each other to accommodate proper spacing of filaments. The elastic members of the two sets 22, 24, can be interspersed among one another without any of the elastic members overlapping one another. The elastic members 22, 24 may be interspersed in an alternating pattern, as shown in FIG. 8, or any other pattern, or the elastic members 22, 24 may be interspersed completely randomly, as shown in FIGS. 9 and 10.

The methods of forming the differentially-stretched elastic laminate 20 are not limited to the vertical filament laminate embodiment shown in FIG. 12. For example, a low capital vertical-filament stack can be added to a continuous-filament stretch-bonded laminate process. Alternatively, the differential stretch can be accomplished by adding a second spin plate and individual chill roll or a chill roll set to a vertical filament lamination process. Also, an extra vertical-filament extrusion beam could facilitate different polymer stretches. Furthermore, two sets of pre-formed filaments could be unwound from different spools or unwinds with differing unwind speeds to create differentially elongation in the nip. Various low-capital equipment alternatives are possible to enable this material design.

Vertical filament lamination (VFL) processes are described in greater detail in PCT Publication WO01/87589, published 22 Nov. 2001, and entitled ELASTIC STRANDED LAMINATE WITH ADHESIVE BONDS AND METHOD OF MANUFACTURE by H. M. Welch et al., incorporated herein by reference in its entirety in a manner consistent with the invention. Examples of continuous filament stretch-bonded laminate (CF-SBL) processes are described in U.S. Pat. No. 5,385,774 issued to Wright, also incorporated herein by reference in its entirety in a manner consistent with the invention.

Pre-formed elastic strands are also contemplated to be within the scope of this invention. The pre-formed elastic strands may be unwound from a roll and used in one or both sets of elastic members 22, 24. Such pre-formed strands include LYCRA from Invista, and GLOSPAN, which is available from Globe Manufacturing Co. Pre-formed strands may give the laminate 20 improved elastic performance in terms of stretch and stress relaxation (load over time).

The elastic members 22, 24 can be attached to the facing layer substrates 26, 28 using any suitable attachment technique, as known to those skilled in the art. For example, the attachment may be carried out using adhesive bonding, thermal point bonding, ultrasonic bonding, or the like. The method in FIG. 12 includes a meltblown adhesive die 44 from which a meltblown adhesive is applied to one of the facing layer substrates 26 to attach the elastic members 22, 24 between the two facing layer substrates 26, 28.

After the formed differentially-stretched elastic laminate 20 passes through a pair of nip rolls 46, the laminate 20 may be wound onto a roll 48 for storage. As the elastic members 22, 24 relax during the winding, the higher stretched set of elastic members 22 gathers the facing layer substrates 26, 28 and the other set of elastic members 24, as illustrated in FIGS. 2 and 6.

The resulting differentially-stretched elastic laminate 20 can be incorporated into a waist band, a side panel, a leg band, or any other suitable portion of such personal care articles as training pants 54 (FIG. 13), diapers, certain feminine hygiene products, adult incontinence products, other personal care or medical garments, and the like, to promote easier donning and better fit characteristics compared to conventional stretch-bonded laminates. More particularly, the differentially-stretched elastic laminate 20 delivers lower extension tension, a flatter stress/strain curve, and improved hysteresis compared to single-stretch stretch-bonded laminates, as illustrated in the example below, thereby promoting improved fit and broader fit range of a personal care article. The differentially-stretched elastic laminate 20 lowers extension tension over a given range without a significant impact on the retractive tension or stress relaxation.

In certain embodiments at least one of the substrates 26, 28 may be a disposable absorbent garment outer cover, body side liner, or other integral component of a personal care article. The elastic members 22, 24 may be unwound in a converting process to create improved elastic components during manufacture of the personal care article. For example, two sets of unwinds with different surface speeds may deliver differential stretch or elongation of the pre-formed strands directly during the manufacture of the absorbent article. This may be especially useful in machine-direction converting process leg elastic applications or cross-direction converting process waist elastic applications.

For ease of explanation, the incorporation of the differentially-stretched elastic laminate 20 into a personal care article will be described in terms of a training pant 54, as illustrated in FIG. 13. However, the differentially-stretched elastic laminate 20 may just as easily and just as beneficially be incorporated into various other types of personal care articles. Examples of diapers and training pants are described in detail in U.S. Pat. No. 6,663,611 issued to Blaney et al. and U.S. Pat. No. 6,613,033 issued to Popp et al., both of which are incorporated herein by reference in their entirety in a manner consistent with the invention.

The training pant 54 in FIG. 13 includes a chassis 58 defining a waist opening 60 and two opposing leg openings 62. Side panels 64 may be refastenable, or non-refastenable as in the illustrated training pants 54. It will be appreciated that any number of side panel configurations may be used in the context of the invention. The elastic laminate materials 20 may be used to form the side panels 64 in part or in their entirety. A waistband region 66 is configured to encircle the waist of the wearer when worn; however, the full circumference of the waistband 66 may or may not be elasticized. Thus, the elastic laminate material 20 may be used in the full circumference of the waistband 66 or merely a portion of the waistband 66. Similarly, the elastic laminate materials 20 may be used in the full circumference of the leg openings 62 or around merely a portion of the leg openings 62 to form a leg band 68. Leg band components may include leg elastics, leg cuffs, containment flaps, and/or any additional components.

Upon initial elongation of the laminate 20 during donning, the elastic members 22 with the greatest amount of stretch will begin stretching at a low tension (FIGS. 3 and 7) due to the laminate having half of the basis weight of a traditional material with the same total elastic basis weight. At a point, determined by the amount of stretch on the second set of elastic members 24, the second set of elastic members 24 will also begin stretching after the gathering or corrugations are removed and tension in the laminate 20 will then increase (FIG. 4).

Consequently, the differentially-stretched elastic laminate 20 delivers low extension tension with improved hysteresis without significantly impacting the retractive tension or stress relaxation over time, compared to other elastic materials, as shown in the Example below.

### EXAMPLE

This example was carried out to produce differentially-stretched materials in accordance with the invention, and comparing these materials to conventional stretch-bonded laminates (control). In this example, a number of differentially-stretched laminates were tested to show that as the set of filaments (films, LYCRA) with a higher elongation retracted back during winding it also gathered back, along with the facing, the second set of filaments. As the elastic laminate was stretched, it pulled out the gathered facing at a much lower tension than a material with the same total basis weight and a set of filaments attached at a single elongation. As the material was stretched further, the second set of filaments began to stretch, thereby increasing both the extension and retraction tension.

The first set of filaments delivers ultimate stretch capability and tension over the entire extension range while the second set of filaments delivers additional retractive force after initial elongation. The additional retractive force attributable to the second set of filaments is intended to be utilized when the wearer elongates the elastic during use, without delivering additional extension tension during the initial portion of extension or when the wearer is donning the garment.

The trials were carried out using samples produced on a VFL line including two extruders and two chill rolls, as shown in FIG. 12. KRATON filaments, films and LYCRA strands were all used as elastic materials and were used to produce a variety of samples. Several combinations of these materials applied at differing amounts stretch were produced. For the bulk of the trials one elastic member or set of elastic members was constantly kept at 5 times stretch. The other member or set of elastic members was varied from 1.2× to 4×. With the exception of the LYCRA strands, a blend of 80% by weight KRATON 1730 styrene-(ethylene-propylene)-styrene-(ethylene-propylene) tetrablock copolymer from Kraton Polymers Inc., 7% by weight PETROTHANE NA601 polyethylene wax from Quantum Chemical Co. or EPOLENE C-10 wax from Eastman Chemical Company, and 13% by weight REGALREZ 1126 tackifier from Eastman Chemical Co., the blend is also known as KRATON 6638, was the elastic polymer used for the trial. Both filaments and films of KRATON 6638 were run throughout the trials. With the exception of the control, the material basis weight (calculated based on nip speed) remained at a constant 5 gsm for each elastic component, or 10 gsm total. Facings of bicomponent spunbond 0.4 osy, 2 denier per filament, 50% linear low-density polyethylene, 50% polypropylene, point-bonded with a wire-weave bond pattern were used throughout the trial. All samples were tested with the 3-Cycle Hysteresis and the Stretch-to-Stop Tests, both of which are described in greater detail in the Test Methods section below. All samples, including the control samples, were attached to PRISM facings with 3 gsm H2096 meltblown adhesive, available from Bostik-Findley Adhesives of Wauwatosa, Wis. The LYCRA strands were LYCRA 540 dtex available from Invista of Wichita, Kans. All KRATON materials were KRATON 6638 available from Kraton Polymers Inc. of Houston, Tex. In nearly all samples, the winder setting was 0.45; however, in the samples marked with an asterisk (*) in the far left column, the winder setting was 0.80.

TABLE 1
Stretch Characteristics of Differentially-Stretched Elastic Laminates
vs. Control VFL

| | | L @ 50% | |
|---|---|---|---|
| 1^{st} Elastic | 2^{nd} Elastic | (grams) | % STS |
| (Control) 5 gsm Kraton 5x | | 245.98 | 228.74 |
| filaments | | | |
| 2x Lycra | 5x Kraton 5 gsm filaments | 266.92 | 210.44 |
| 3x Lycra | 5x Kraton 5 gsm filaments | 445.76 | 204.31 |
| (Code 4) 4x Lycra | 5x Kraton 5 gsm filaments | 449.66 | 230.21 |
| (Code 5) 1.5x Lycra | 5x Kraton 5 gsm filaments | 223.58 | 219.52 |
| (Code 6) 1.2x Lycra | 5x Kraton 5 gsm filaments | 222.64 | 226.05 |
| (Code 7 - Control) 4x Lycra | | 244.12 | 225.55 |
| (Control) 3x Lycra | | 264.5 | 178.81 |
| (Control) 2x Lycra | | 267.76 | 93.24 |
| (Control) 1.5x Lycra | | N/A | 46.05 |
| (Control) 1.2x Lycra | | N/A | 17.81 |
| (Code 12 - Control) 5x Kraton 10 gsm | | 465.56 | 228.32 |
| (Control) 5x Kraton 15 gsm | | 613.38 | 245.79 |
| 2x Lycra | 5x Kraton 5 gsm filaments | 242.2 | 215.58 |
| 1.5x Lycra | 5x Kraton 5 gsm filaments | 222.4 | 224.43 |
| 1.2x Lycra | 5x Kraton 5 gsm filaments | 235.44 | 227.37 |
| 5x Kraton 11 gsm film | 3x Kraton 5 gsm filaments | 458.42 | 196.84 |
| *5x Kraton 11 gsm film | 3x Kraton 5 gsm filaments | 402.8 | 146.27 |
| 5x Kraton 11 gsm film | 2x Kraton 5 gsm filaments | 368 | 171.77 |
| *(Control) 5x Kraton 11 gsm film | | 292.3 | 182.49 |
| 5x Kraton 5 gsm filaments | 3x Kraton 10.25 gsm film | 331.68 | 231.8 |
| 5x Kraton 5 gsm filaments | 2x Kraton 10.25 gsm film | 179.46 | 205.74 |
| 1.2x Kraton 5 gsm filaments | 5x Kraton 5 gsm filaments | 222.52 | 230.45 |
| 2x Kraton 5 gsm filaments | 5x Kraton 5 gsm filaments | 265.98 | 221.07 |
| 3x Kraton 5 gsm filaments | 5x Kraton 5 gsm filaments | 356.02 | 204.94 |
| *3x Kraton 5 gsm filaments | 5x Kraton 5 gsm filaments | 338.5 | 188.15 |
| *3x Kraton 5 gsm filaments | 5x Kraton 5 gsm filaments | 281.42 | 176.01 |
| 4x Kraton 5 gsm filaments | 5x Kraton 5 gsm filaments | 415.72 | 226.72 |
| 1.2x Kraton 5 gsm filaments | 5x Kraton 5 gsm filaments | 216.48 | 227.51 |
| 2x Kraton 5 gsm filaments | 5x Kraton 5 gsm filaments | 241.42 | 222.21 |
| 1.2x Kraton 5 gsm filaments | 5x Kraton 5 gsm filaments | 187.4 | 206.3 |
| 1.27x Kraton 5 gsm filaments | 6x Kraton 5 gsm filaments | 186 | 238.3 |
| 1.4x Kraton 5 gsm filaments | 7x Kraton 5 gsm filaments | 203.4 | 280 |
| 1.2x Kraton 5 gsm filaments | 5x Kraton 5 gsm filaments | 191.6 | 201.7 |
| 2.8x Kraton 5 gsm filaments | 6x Kraton 5 gsm filaments | 254.6 | 220 |
| 1.2x Kraton 5 gsm filaments | 6x Kraton 5 gsm filaments | 208.2 | 216.7 |
| 1.2x Kraton 5 gsm filaments | 7x Kraton 5 gsm filaments | 260.2 | 243.3 |

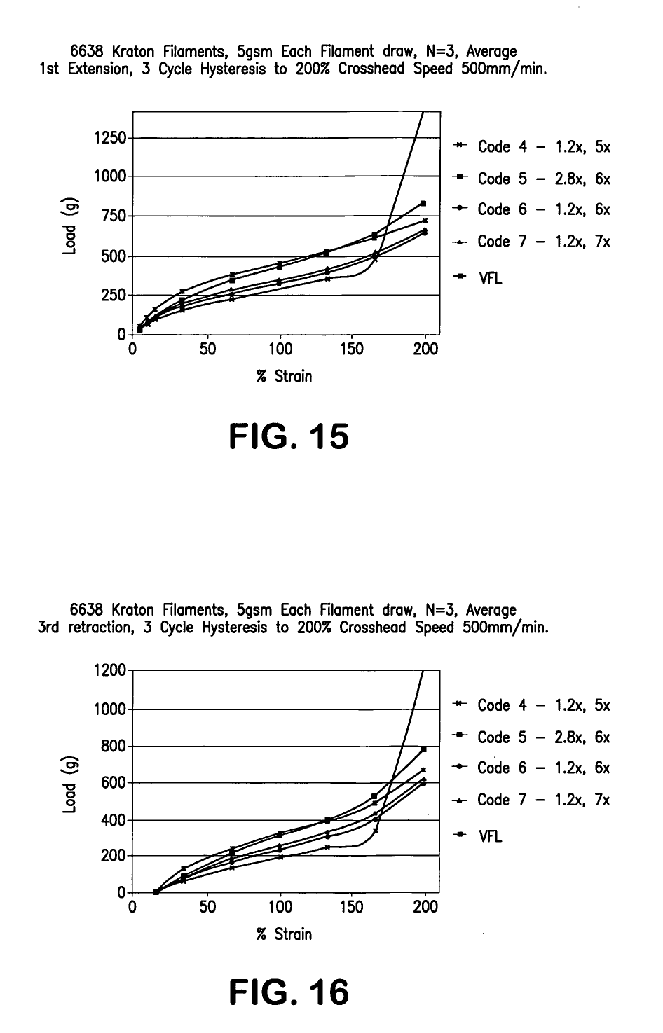

Materials made with two sets of differentially-stretched filaments displayed some interesting tension and hysteresis properties when compared to a control single-stretch VF-SBL material. Materials produced during the trials using two sets of filaments all displayed a lower extension tension than the single-stretch VF-SBL. All differentially-stretched materials also showed a decrease in retractive tension as well. However, the decrease in retractive tension was less than the decrease in extension tension. When analyzing a few of the stress/strain curves (FIGS. 14-16) from the materials produced at the trials, a few interesting shapes are noted. Code 4, a laminate with 1.2× and 5× filaments, has a very flat shape and a low extension tension until approximately 150% strain. At this point the material tension undergoes a rapid increase. This increase is believed to be the material running out of stretch and the pulling of the facing. Code 5 (2.8×, 6×) showed some encouraging curve properties. This sample had a lower than control initial extension tension until 100% strain. At 100% strain the tension has equaled the control curve. This shows the realization of a hybrid material. This material could provide a lower donning tension without sacrificing stress relaxation over time or retractive tension.

The differential stretch materials also show an improvement in hysteresis when compared to single-stretch VF-SBL (Table 2). This represents a material improvement. When placed into a product a material with good hysteresis will offer a more consistent elastic performance.

TABLE 2
Comparison of Hysteresis Load Loss (1^{st} Cycle
Extension Load (g) - 3^{rd} Cycle Retraction
Unloading (g)) at a Given Strain for Codes 4 through 7 and 12 from Table 1

| Code | 5% | 10% | 15% | 33.3% | 66.6% | 100% | 133.3% | 166.6% | 200% |
|---|---|---|---|---|---|---|---|---|---|
| 4 | 44.5 | 78.5 | 100.5 | 99.3 | 94.3 | 96.9 | 108.0 | 137.2 | 189.4 |
| 5 | 37.1 | 78.5 | 114.7 | 139.6 | 132.1 | 126.0 | 121.9 | 115.0 | 54.6 |
| 6 | 36.9 | 81.7 | 112.3 | 107.9 | 96.5 | 93.5 | 93.5 | 91.6 | 39.2 |
| 7 | 35.4 | 85.7 | 119.7 | 114.5 | 96.2 | 92.6 | 89.5 | 83.7 | 34.3 |
| 12 | 52.6 | 116.8 | 154.4 | 149.2 | 140.1 | 137.4 | 133.7 | 123.5 | 55.1 |

The resulting differentially-stretched elastic laminate thus delivers a low extension tension with improved hysteresis without significantly impacting the retractive tension or stress relaxation over time versus single-stretch SBL materials. A material with these properties will lower donning tension and help to improve the fit range when incorporated into personal care articles.

It will be appreciated that details of the foregoing embodiments, given for purposes of illustration, are not to be construed as limiting the scope of this invention. Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention, which is defined in the following claims and all equivalents thereto. Further, it is recognized that many embodiments may be conceived that do not achieve all of the advantages of some embodiments, particularly of the preferred embodiments, yet the absence of a particular advantage shall not be construed to necessarily mean that such an embodiment is outside the scope of the present invention.

### Test Method Procedures

3-Cycle Hysteresis Elongation to 200%

Equilibrium hysteresis of an elastic material is determined using a Sintech tensile frame apparatus equipped with TESTWORKS software to record data. The elastomeric material is cut into strips, each having a width of 3 inches and a length of 6 inches. Both ends of the material are clamped into the opposing jaws of the apparatus.

Each material strip is stretched at a rate of 500 mm/min to a given extension and the area under the curve (representing force X displacement) is measured and recorded as the “loading energy.” In this experiment, each sample was extended to 200%. The material strip is then allowed to recover to a length where the stretching force is zero. During retraction, the area under the curve is again measured and recorded. This is the “unloading energy.”

Hysteresis is determined according to the following equation:

$$\% Hystersis = \frac{loading energy minus unloading energy}{loading energy} \times 100 \%$$

The procedure is repeated for 3 cycles on each sample. Calculations can then be generated using each of the loading and unloading curves. Typically, the first cycle and the third cycle unloading are analyzed and contrasted to characterize elastomeric performance over the 3 cycles. Calculations such as load loss at a given elongation comparing loading to unloading cycles are also useful.

Stretch-to-Stop Test

“Stretch-to-stop” refers to a ratio determined from the difference between the unextended dimension of a stretchable material and the maximum extended dimension of a stretchable material upon the application of a specified tensioning force and dividing that difference by the unextended dimension of the stretchable material. If the stretch-to-stop is expressed in percent, this ratio is multiplied by 100. For example, a stretchable material having an unextended length of 5 inches (12.7 cm) and a maximum extended length of 10 inches (25.4 cm) upon applying a force of 2000 grams has a stretch-to-stop (at 2000 grams) of 100 percent. Stretch-to-stop may also be referred to as “maximum non-destructive elongation.” Unless specified otherwise, stretch-to-stop values are reported herein at a load of 2000 grams. Also reported are tension values from the stress/strain curve. Resultant Load at 50% extension is a typical single point of the curve value reported to characterize the extension force the laminate delivers. In the elongation or stretch-to-stop test, a 3-inch by 7-inch (7.62 cm by 17.78 cm) sample, with the larger dimension being the machine direction, the cross direction, or any direction in between, is placed in the jaws of a Sintech machine using a gap of 5 cm between the jaws. The sample is then pulled to a stop load of 2000 gms with a crosshead speed of about 500 mm/minute. The stretch-to-stop test is done in the direction of extensibility (stretch). Depending upon the material being tested, a greater applied force may be more appropriate. For an elastic composite material the applied force of 2000 grams per 3-inch cross-directional width is typically appropriate.

What is claimed is:

1. An elastic laminate comprising:
a first set of elastic members attached to a substrate while stretched;
a second set of elastic members attached to the substrate while stretched to a lesser extent than the first set of elastic members;
wherein both the substrate and the second set of elastic members are gathered when the first set of elastic members is relaxed.

2. The elastic laminate of claim 1, wherein the first set of elastic members is interspersed among the second set of elastic members without any of the elastic members overlapping one another.

3. The elastic laminate of claim 1, wherein the elastic members in the first set of elastic members have the same basis weight as the elastic members in the second set of elastic members.

4. The elastic laminate of claim 1, wherein the elastic members in the first set of elastic members have a different basis weight than the elastic members in the second set of elastic members.

5. The elastic laminate of claim 1, wherein the elastic members in the first set of elastic members have the same material composition and structure as the elastic members in the second set of elastic members.

6. The elastic laminate of claim 1, wherein the elastic members in the first set of elastic members have a different material composition and/or structure than the elastic members in the second set of elastic members.

7. The elastic laminate of claim 1, wherein the elastic members in the first set of elastic members have different heat retractive properties than the elastic members in the second set of elastic members.

8. The elastic laminate of claim 1, wherein at least one of the first and second sets of elastic members comprises a styrenic block copolymer.

9. The elastic laminate of claim 1, further comprising a second substrate, wherein the first set of elastic members is attached to both the first and the second substrates while stretched, the second set of elastic members is attached to both the first and the second substrates while stretched to a lesser extent than the first set of elastic members, and both the first and the second substrates and the second set of elastic members are gathered when the first set of elastic members is relaxed.

10. The elastic laminate of claim 1, wherein the elastic laminate is incorporated into a personal care article.

11. The elastic laminate of claim 10, wherein the elastic laminate is incorporated into at least one of the group consisting of a waist band, a side panel, and a leg band.

12. The elastic laminate of claim 10, wherein the substrate comprises an integral component of the personal care article.

13. An elastic laminate comprising:
a set of elastic members attached to a substrate while stretched; and
an elastic film attached to the substrate while stretched to a different extent than the set of elastic members;
wherein the substrate and either the set of elastic members or the elastic film are gathered when the laminate is in a relaxed state.

14. A method of producing an elastic laminate, comprising:
attaching a first set of elastic members to a substrate while stretching the first set of elastic members; and
attaching a second set of elastic members to the substrate while stretching the second set of elastic members to a lesser extent than the first set of elastic members.

15. The method of claim 14, comprising stretching the first set of elastic members by about 50% to about 700% while attaching the first set of elastic members to the substrate.

16. The method of claim 14, comprising stretching the second set of elastic members by about 10% to about 500% while attaching the first set of elastic members to the substrate.

17. The method of claim 14, comprising stretching the first set of elastic members by about 10% to about 700% more than the second set of elastic members while attaching the first and second sets of elastic members to the substrate.

18. The method of claim 14, comprising extruding the first set of elastic members onto a first chill roll and extruding the second set of elastic members onto a second chill roll.

19. The method of claim 14, comprising extruding the first set of elastic members through an extrusion die having a different spacing than an extrusion die through which the second set of elastic members is extruded.

20. The method of claim 14, comprising extruding the first set of elastic members through an extrusion die having spacing that is offset from spacing of an extrusion die through which the second set of elastic members is extruded.

21. The method of claim 14, wherein at least one of the first and second sets of elastic members comprises pre-formed elastic members.

22. The method of claim 14, further comprising winding the elastic laminate onto a roll while the first set of elastic members is in a relaxed state and both the second set of elastic members and the substrate are gathered.

23. The method of claim 14, further comprising incorporating the elastic laminate into a personal care article.

24. The method of claim 23, wherein the substrate comprises an integral component of the personal care article, and comprising producing the elastic laminate in a converting assembly process during manufacture of the personal care article.
